(19) United States
(12) Patent Application Publication
(10) Pub. No.: US 2019/0012742 A1
(43) Pub. Date: Jan. 10, 2019

(54) GROUP INVESTMENT MANAGEMENT PLATFORM

(71) Applicant: Baza, Inc., Salt Lake City, UT (US)

(72) Inventors: Douglas Patricio Quezada, Provo, UT (US); Matthew John Mantyla, Draper, UT (US)

(21) Appl. No.: 15/642,231

(22) Filed: Jul. 5, 2017

(51) Int. Cl. G06Q 40/06; G06Q 10/10; H04L 29/06

(52) U.S. Cl. CPC G06Q 40/06; G06Q 10/107; H04L 67/10; H04L 63/101; H04L 63/102

(57) ABSTRACT

A group investment management platform can be implemented using a unique arrangement and configuration of underlying data structures, architecture, and functionality which enable the group investment management platform to be distributed across a large network of user devices in an efficient and secure way. This underlying configuration enhances the abilities of the respective servers and user devices in ways that were not previously possible with existing group investment management platforms.

### CROSS-REFERENCE TO RELATED APPLICATIONS

N/A

### BACKGROUND

Due to regulations and security issues, it can be difficult to develop software, and particularly mobile applications, that involves finances. However, with the increased use of mobile devices, mobile applications are an effective and efficient way to enable users to perform financial tasks. Furthermore, individuals are oftentimes more motivated to perform a task when they join together with other individuals to pursue a common goal. Accordingly, there is a need for a computing platform that can enable groups of users to invest together in a safe and secure manner.

### BRIEF SUMMARY

The present invention extends to methods, systems, and computer program products that enable the provision of a group investment management platform. The invention itself is not merely directed to a group investment scheme, but is directed to a unique arrangement and configuration of the underlying data structures, architecture, and functionality which enable a group investment management platform to be distributed across a large network of user devices in an efficient and secure way. This underlying configuration enhances the abilities of the respective servers and user devices in ways that were not previously possible with existing group investment management platforms.

In one embodiment, the present invention is implemented as a group investment management platform that includes a management server that implements a group management service and a group management database, and a transaction server that implements a transaction service and a transaction database. The group management service is configured to: interface with user devices to receive requests to create groups within the group investment management platform; in response to receiving a request to create a group, update one or more data structures in the group management database to define the group and membership in the group; and interface with the transaction server to instruct the transaction service to obtain and manage account information for members of the group. The transaction service is configured to: in response to requests from the group management service, interface with the user devices to retrieve the account information in a secure manner; in response to receiving the account information, update one or more data structures in the transactions database; and interface with the group management service to notify the group management service when account information has been obtained from the members of the group.

In another embodiment, the present invention is implemented as a method for implementing a group investment management platform. A management server is configured to include a group management service, while a transaction server is configured to include a transaction service. The group management service receives a request to create a group. The request specifies a plurality of individuals as members of the group and a pay in amount for the group. The group management service creates an entry in a groups data structure that defines the group. The entry includes an identifier of the group and the pay in amount. The group management service creates an entry in a group membership data structure for each of the individuals. Each entry associates the individual with the group. The group management service sends invitations to each of the individuals to join the group. In response to an individual accepting the invitation, the group management service causes the transaction service to request account information from the individual. In response to receiving account information from each of the individuals, the group management service instructs the transaction service to deduct the pay in amount from an account of each individual using the corresponding account information. After the pay in amount has been deducted from the account of each individual, the group management service instructs the transaction service to transfer an amount equal to the sum of the deducted pay in amounts to the account of one of the individuals.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

Understanding that these drawings depict only typical embodiments of the invention and are not therefore to be considered limiting of its scope, the invention will be described and explained with additional specificity and detail through the use of the accompanying drawings in which:

FIG. 1 illustrates an example computing environment in which the present invention can be implemented;

FIGS. 2, 2A, and 2B illustrate an example architecture of a management server that can be employed in embodiments of the present invention;

FIGS. 3, 3A, and 3B illustrate an example architecture of a transaction server that can be employed in embodiments of the present invention;

FIGS. 4A-4H illustrate a sequence of steps that can be performed by the underlying architecture to enable users to efficiently and securely establish a group in a group investment management platform; and

FIGS. 5A and 5B illustrate a sequence of steps that can be performed by the underlying architecture to effectuate transfers pertaining to a group in a group investment management platform.

### DETAILED DESCRIPTION

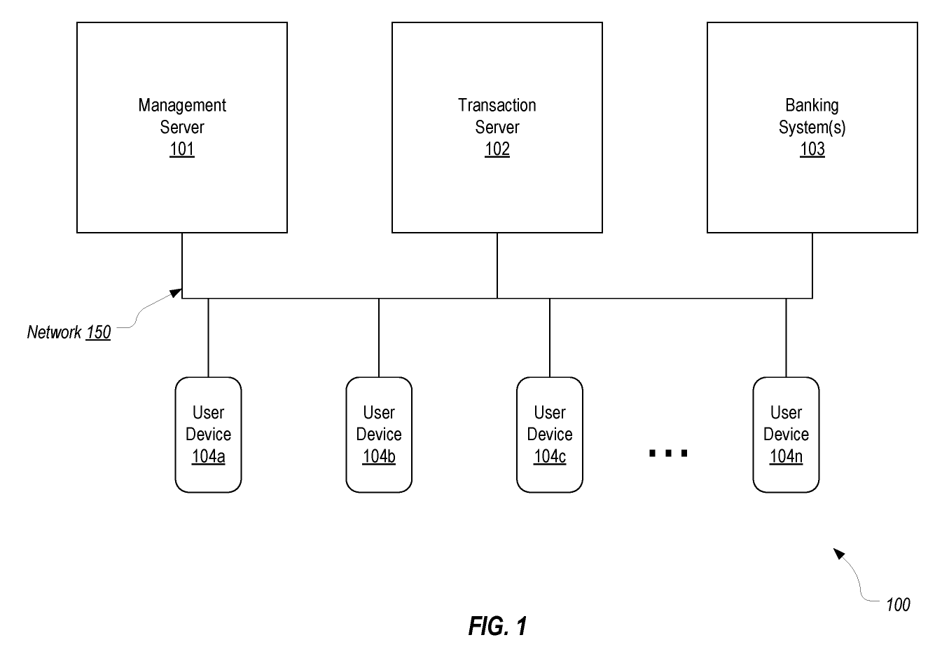

FIG. 1 illustrates an example computing environment 100 in which the present invention can be implemented. Computing environment 100 includes a management server 101, a transaction server 102, one or more banking systems 103, and a number of user devices 104a-104n (where n represents any integer) which are interconnected via a network 150. Network 150 may typically represent the internet, but any suitable network connection could be employed. Also, in some embodiments, it is possible that not all of the components of computing environment 100 will be connected to the same network.

The group investment management platform of the present invention will typically encompass components of management server 101 and of transaction server 102 as well as a mobile application or browser-based interface on user devices 104a-104n. For ease of illustration, it will be assumed hereafter that each of user devices 104a-104n includes a mobile application that is configured to interface with management server 101 and transaction server 102 for purposes of initiating or responding to various actions within the group investment management platform. Importantly, the present invention is not merely directed to such actions, but is directed to the underlying architecture that enables these actions to be carried out in an efficient and secure manner that was not previously available with prior art techniques.

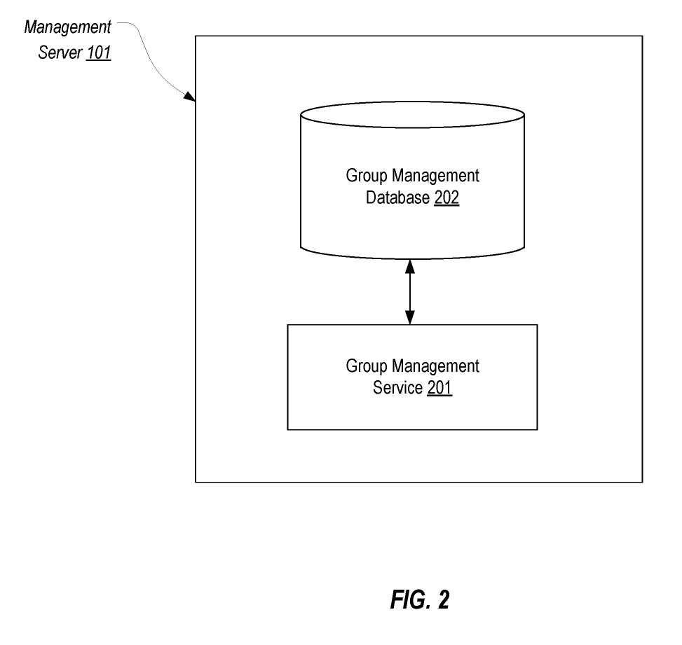

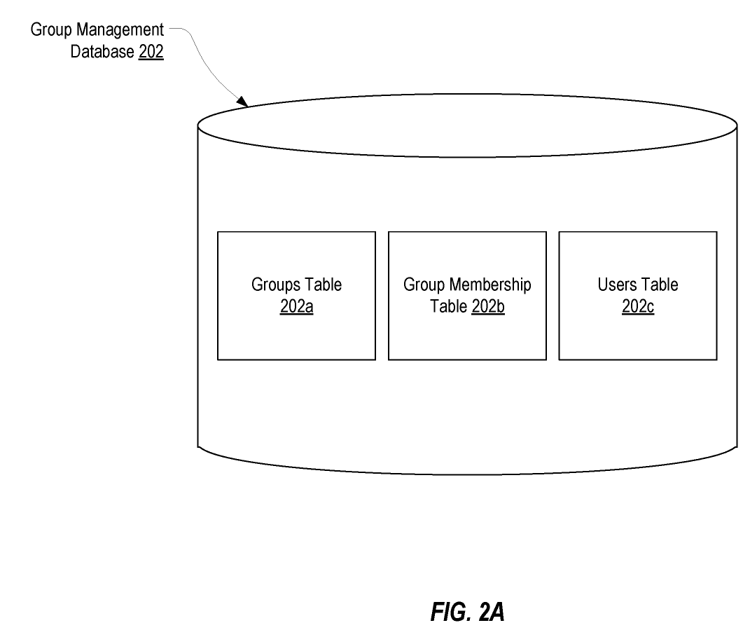

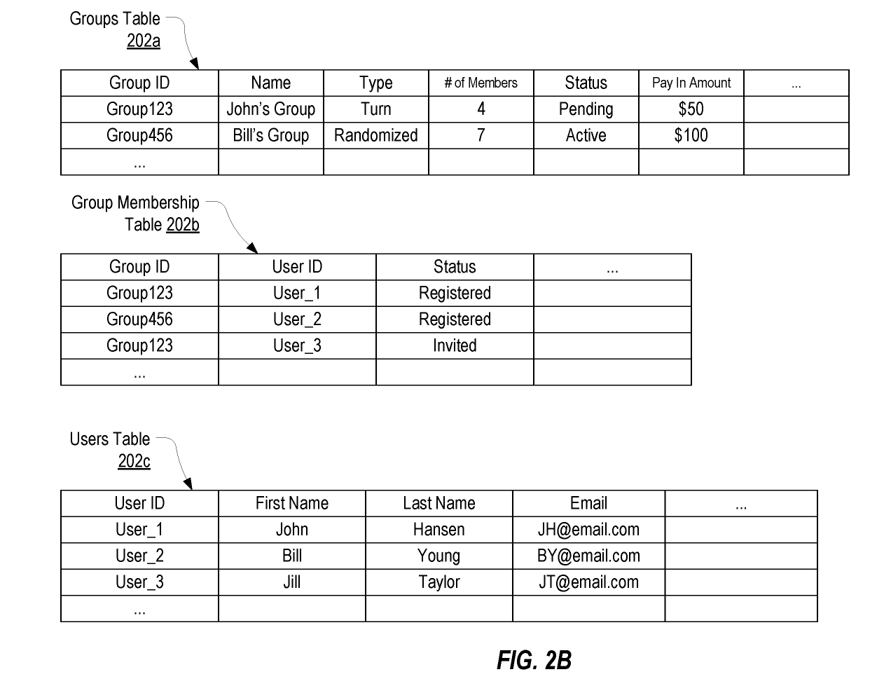

FIG. 2 illustrates various components of management server 101, namely, a group management service 201 and a group management database 202. Group management service 201 comprises the executable components that are configured to send communications to and receive communications from user devices 104a-104n (e.g., by interfacing with a mobile application installed on user devices 104a-104n), the executable components that are configured to manage the creation of user accounts and groups within the group investment management platform based on communications with user devices 104a-104n, and the executable components that are configured to communicate with transaction server 102 in accordance with configuration settings of users and groups.

Group management database 202 comprises the various data structures (e.g., tables) that are employed to define users, groups, and group membership. For example, as shown in FIG. 2A, group management database 202 may include a groups table 202a, a group membership table 202b, and users table 202c. Groups table 202a can be employed to store entries which define a group that has been created on the group investment management platform including configuration settings of the group. Users table 202c can be employed to store entries which define individual users of the group investment management platform. Group membership table 202b can be employed to define which users are members of each group.

FIG. 2B provides examples of how these tables may be structured including example entries in each table. As shown, users table 202c can include columns for User ID, First Name, Last Name, and Email Address among potentially many other data elements such as address, user type (e.g., web-based or app-based), additional contact information, etc. For illustrative purposes, users table 202c is shown as including three user entries which represent users John Hansen, Bill Young, and Jill Taylor.

Groups table 202a can include columns for Group ID, Name (which can be user defined), Type (e.g., turn-based or randomized payout), Number of Members, Status, and Pay In Amount among possibly many others such as a specified pay in date and/or pay out date. By way of example, groups table 202a is shown as having two entries: (1) a group with an ID of Group123 that is named John's Group, uses turn-based payout, has four members and a pay in amount of $50, and is pending; and (2) a group with an ID of Group456 that is named Bill's group, uses randomized payout, has seven members and a pay in amount of $100, and is active. When a group is configured to perform turn-based payout, the user that receives the periodic payout (as will be further described below) will be in accordance with some defined order (which may be defined in groups table 202a). In contrast, when a group is configured to perform randomized payout, the user that receives the periodic payout will be selected randomly from among the members of the group that have yet to receive a payout.

Group membership table 202b can include columns for Group ID, User ID, and Status among potentially many others such as a data element which identifies whether the corresponding user has already received a payout as part of the group. In FIG. 2B, group membership table 202b is shown as including an entry which defines that User_1 is a registered member of Group123, an entry which defines that User_2 is a registered member of Group456, and an entry which defines that User_3 is an invited (but not registered) member of Group123. As can be seen, group membership table 202b can include an entry for each member of each group. For example, because Group456 has seven members, group membership table 202b could include seven Group456 entries each of which defines one of the seven members. As mentioned above, group membership table 202b could include a column which defines whether the corresponding user has received a payout. Such values could then be employed by group management service 201 to select which user should receive the next payout.

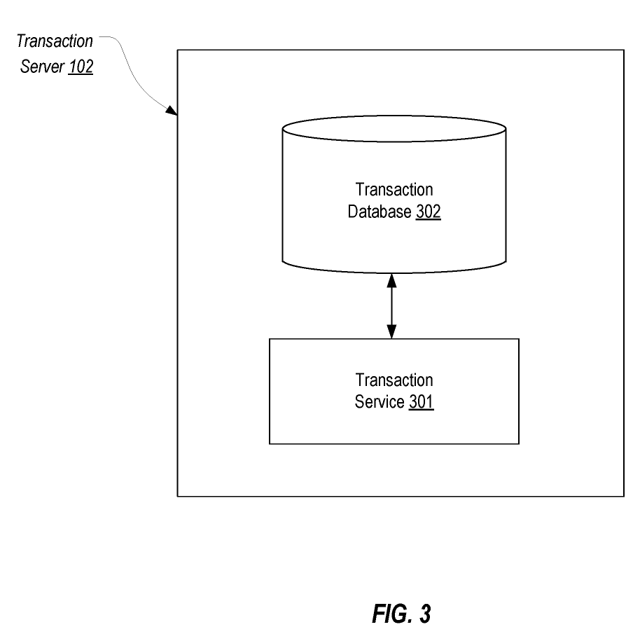

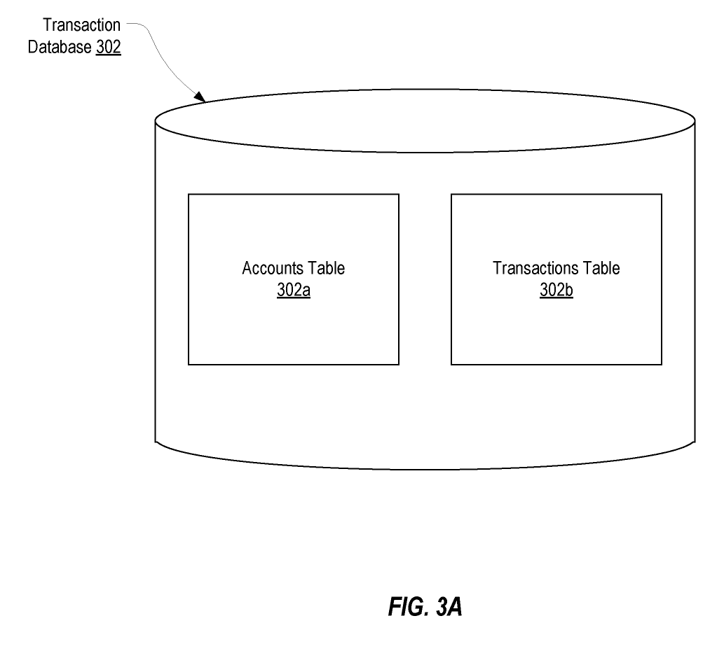

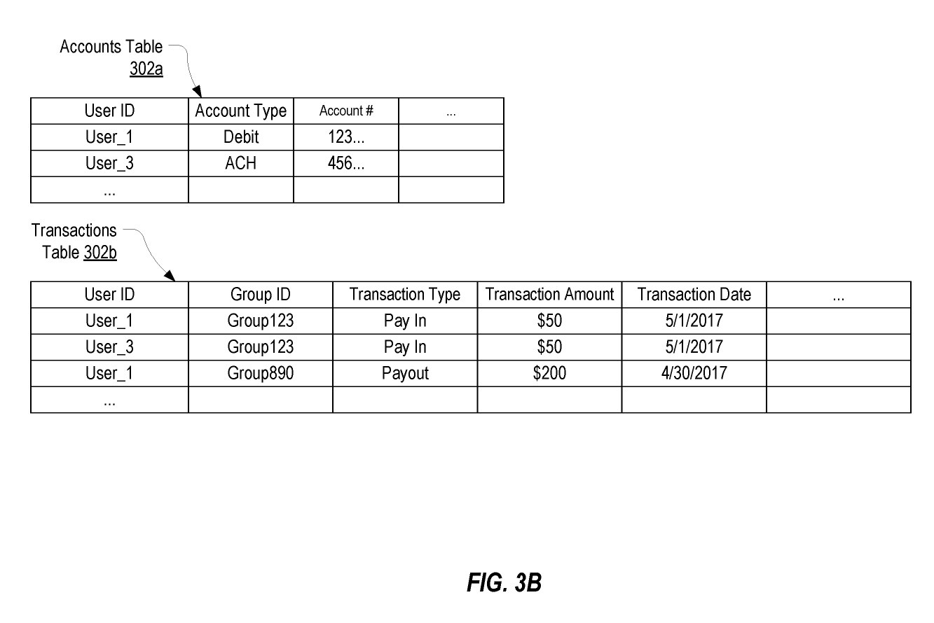

FIG. 3 illustrates various components of transaction server 102, namely, a transaction service 301 and a transaction database 302. Transaction service 301 comprises the executable components that are configured to send communications to and receive communications from user devices 104a-104n, the executable components that are configured to interface with banking system(s) 103, and the executable components that are configured to communicate with management server 101.

Transaction database 302 comprises the various data structures (e.g., tables) that are employed to define the users' financial accounts and transactions that have been made with those accounts. For example, as shown in FIG. 3A, transaction database 302 may include an accounts table 302a and a transactions table 302b. Accounts table 302a can be employed to store entries which define financial accounts that the users have specified should be used by the group investment management platform. Transactions table 302b can be employed to maintain a log of all transactions that transaction service 301 has caused to be performed against any of the accounts defined in accounts table 302a.

FIG. 3B provides examples of how these tables may be structured including example entries in each table. As shown, accounts table 302a can include columns for User ID, Account Type, and Account Number among potentially many other data elements such as Routing Number (in the case of ACH), financial institution information (e.g., a name of a bank or credit union with which the user has the account or a type of debit card), or any other information that may be necessary or useful for effectuating a transaction. For illustrative purposes, accounts table 302a includes an entry that defines that the user having the user ID of User_1 has registered a debit card with a number of 123 . . . , and an entry that defines that the user having user ID of User_3 has registered for ACH transactions against account number 456 . . . .

Transactions table 302b can include columns for User ID, Group ID, Transaction Type, Transaction Amount, and Transaction Date among possibly many others. As shown, transactions table 302b includes an entry which defines that a pay in transaction of $50 was made on May 1, 2017 to User_1's registered account as part of the user's membership in Group123, and an entry which defines that a pay in transaction of $50 was made on May 1, 2017 to User_3's registered account as part of the user's membership in Group123. Similarly, transactions table 302b includes an entry which defines that a payout transaction of $200 was made on Apr. 30, 2017 to User_1's registered account as part of the user's membership in Group890.

Although FIGS. 2B and 3B illustrate the use of tables as the underlying data structures, any other suitable type of data structure can be employed to store the pertinent data. Of importance is the fact that the data is stored with the proper relationships as described above. Also, in typical and even preferred embodiments, transaction server 102 can be physically (or at least logically) separate from management server 101 (e.g. by allowing group management service 210 to communicate with transaction service 302 only via a secure protocol connection such as SSH). In this way, transaction database 302 can be configured in a manner that complies with governing regulations regarding the storage of sensitive payment information without requiring the other data (e.g., the data stored in group management database 202) to be subject to the same restrictive features. This can allow management server 101 to be more lightweight and responsive to thereby enhance the user experience without sacrificing the security of the users' sensitive data.

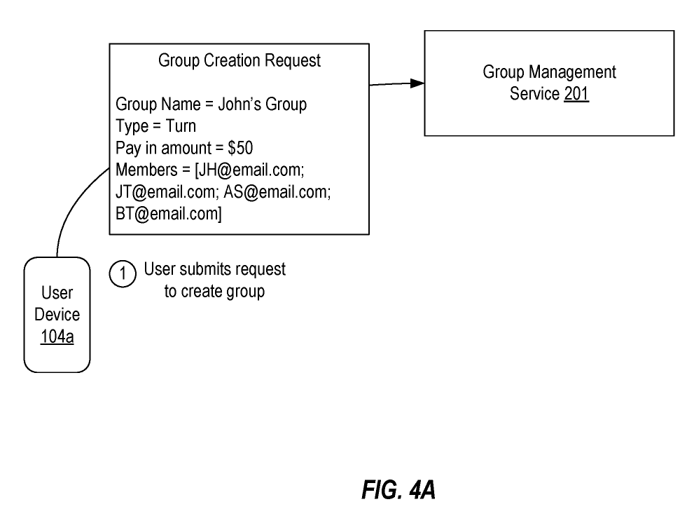

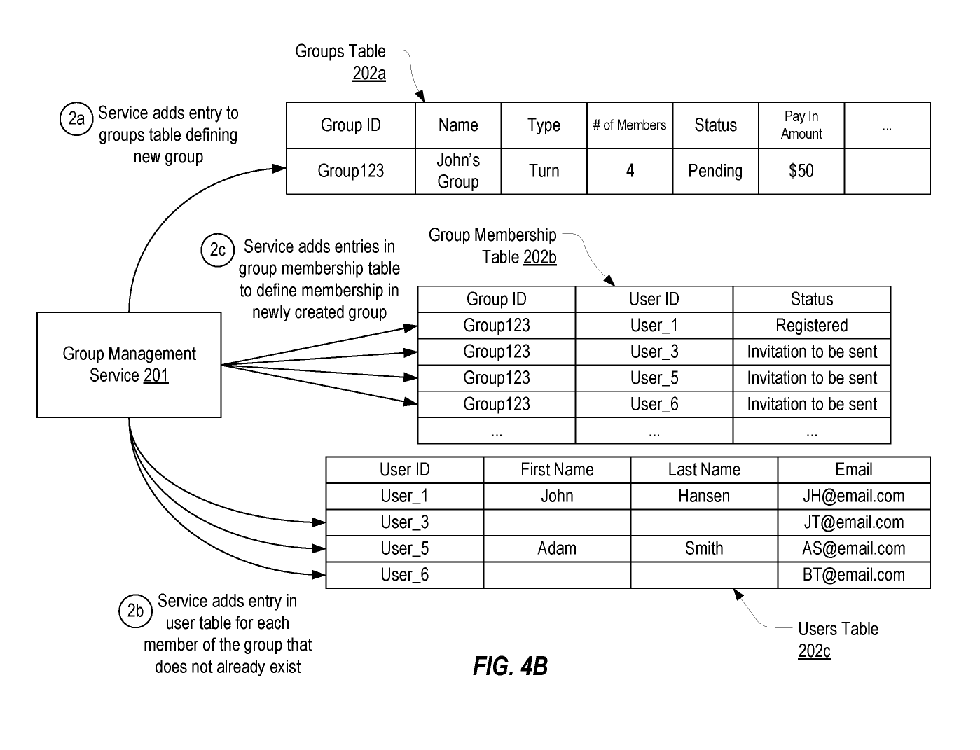

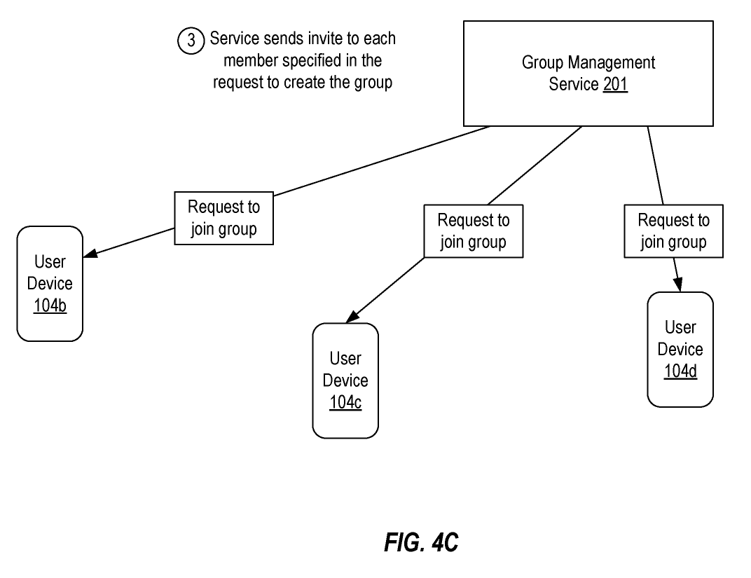

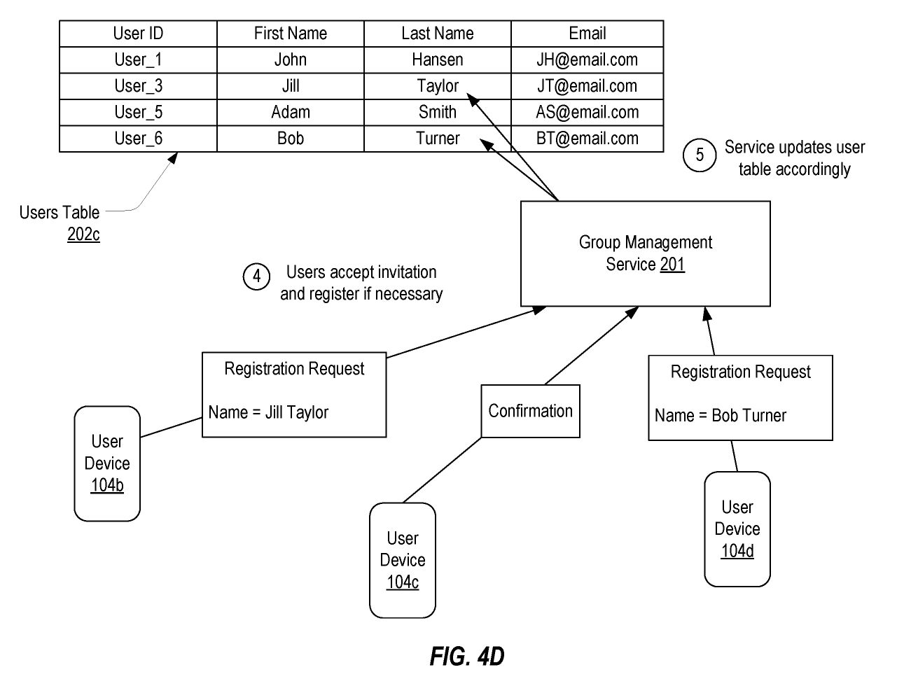

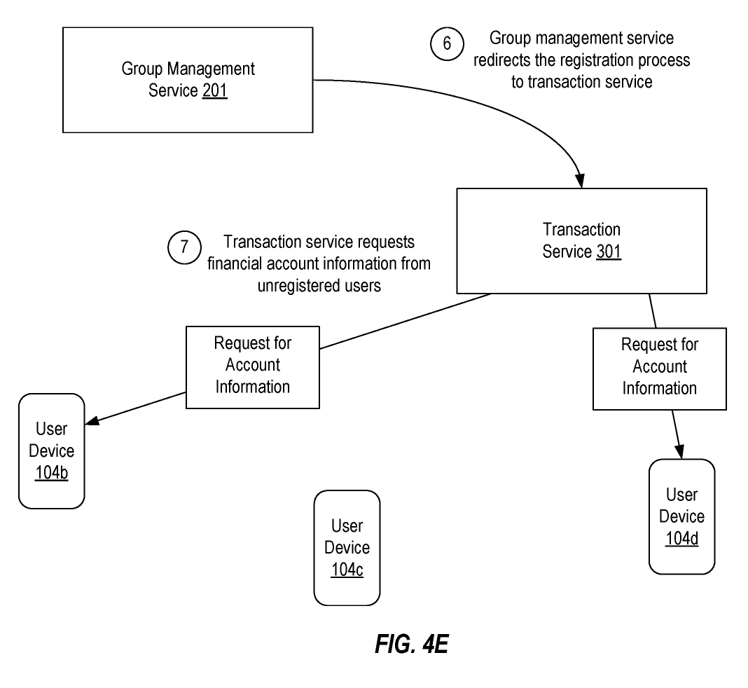

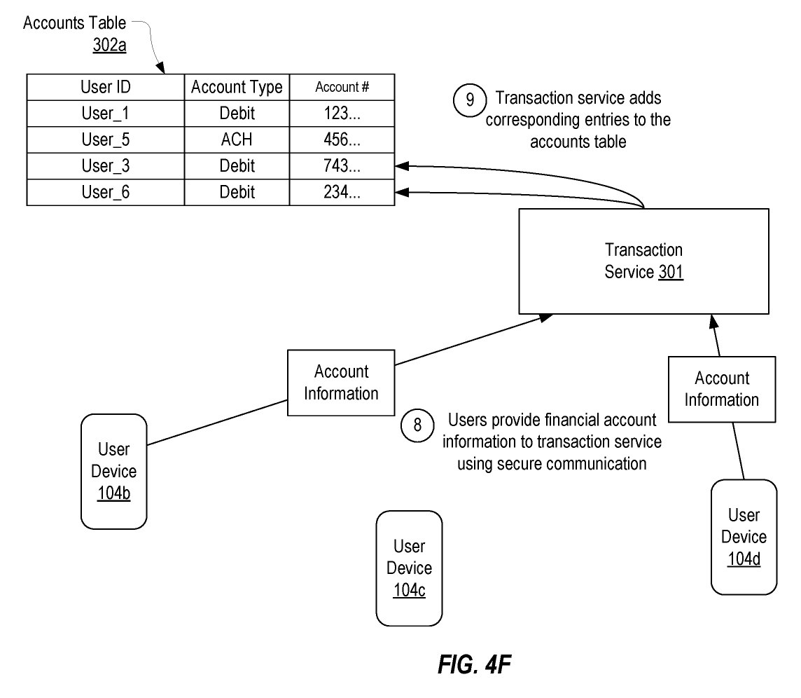

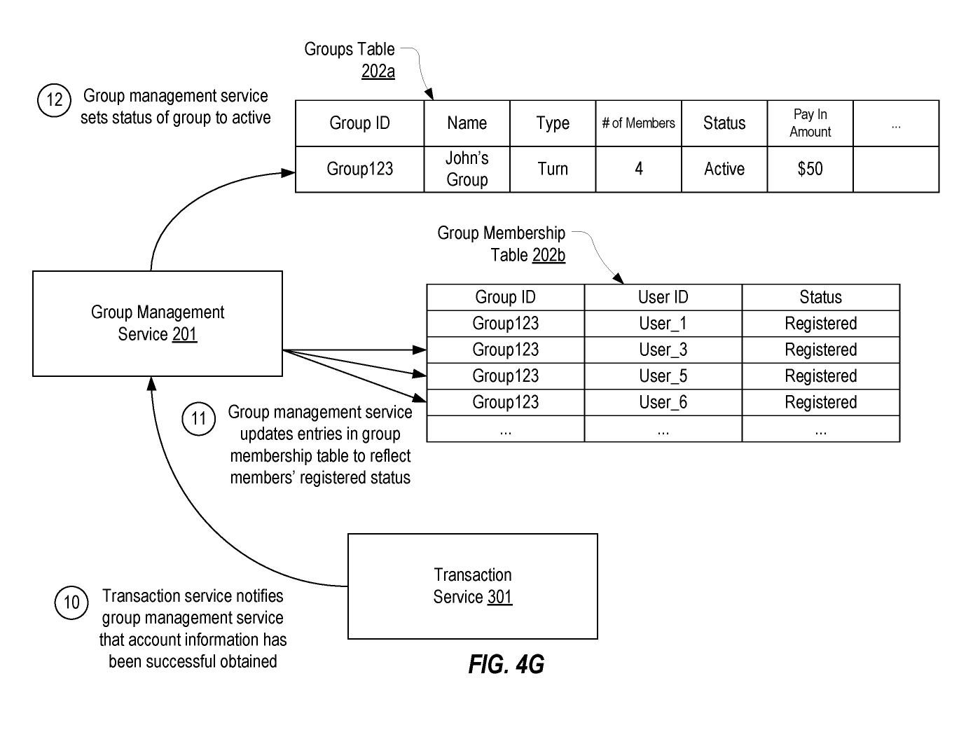

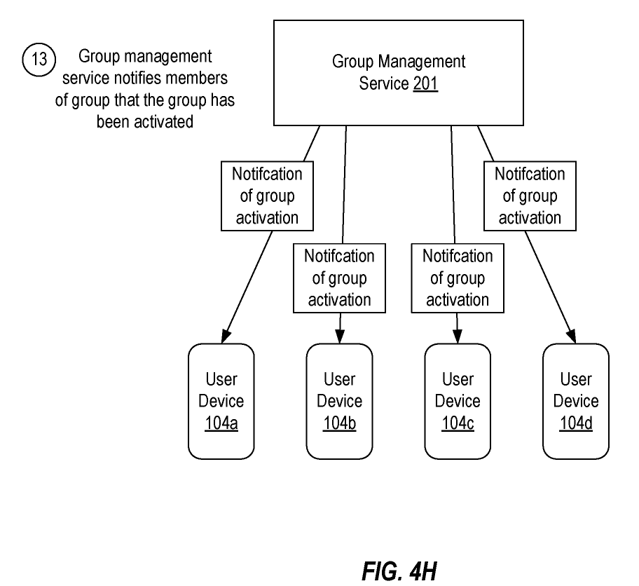

FIGS. 4A-4H illustrate how the underlying components of the group investment management platform can function to enable a group to be created and managed in an efficient and secure manner. In FIG. 4A, it will be assumed that a user of user device 104a, John Hansen, has employed a mobile application to interface with group management service 201. As part of this interaction, and as represented in step 1, John Hansen provides input to cause a request to create a new group to be submitted. As shown, this input can include a group name (John's Group), a group type (Turn), a pay in amount ($50), and an identification of the members of the group. In this example, it will be assumed that members are identified by their email addresses such that the group creation request includes the email addresses: JH@email.com, JT@email.com, AS@email.com, and BT@email.com. JH@email.com is assumed to be John Hansen's email address and may have been automatically included because John is the creator of the group.

In this example, it is assumed that John Hansen was already registered as a user of the group investment management platform prior to submitting the group creation request. However, if John had not been previously registered, the group creation request (or an accompanying request) could have included any additional information about John Hansen that is required to register a user.

Turning now to FIG. 4B, in response to receiving the group creation request, group management service 201 can perform a number of tasks as represented in steps 2a-2c. In step 2a, group management service 201 can update the groups table 202a by adding an entry for the requested group. For example, based on the content of the group creation request, FIG. 4B shows that an entry has been created having a group ID of “Group123” (which may be internally generated and assigned to the group for the purpose of uniquely identifying the group within the platform), a name of “John's Group,” a type of “Turn,” a number of members of “4” and a pay in amount of “$50.” Also, the status of the group is set to pending which represents that the group has not yet been fully configured/confirmed.

In step 2b, group management service 201 can access users table 202c to determine which, if any, of the individuals identified in the group creation request are already registered users. In this example, this can be accomplished by searching users table 202c for each email address that is included in the group creation request. As indicated above, it is assumed that John Hansen was already registered and therefore an entry in users table 202c that includes JH@email.com will be found. This entry can include a unique identifier of User_1 for John Hansen and can also identify John and Hansen as the first and last name of the user. It will also be assumed that an entry that includes AS@email.com already exists indicating that the corresponding individual is also a registered user. As shown, this user, Adam Smith, has a user ID of User_5. It will be further assumed that the individuals having the email addresses JT@email.com and BT@email.com are not registered users and therefore group management service 201 will not locate an entry for these email addresses. In response, group management service 201 can update users table 202c to create entries for both email addresses. The creation of the entries can include assigning a user ID to each entry (User_3 and User_6 respectively). However, based on the assumption that the group creation request did not include first and last names for the group members, the first name and last name fields for these two entries will temporarily remain unpopulated. It is noted that it is equally possible that the user that creates the group could also input the members first and last names in addition to an email address or other form of contact information (e.g., a mobile phone number) in which case, this information could be added to the corresponding entries.

Once an entry has been created in groups table 202a for the group and once an entry for each specified member of the group has been created in users table 202c, group management service 201 can update group membership table 202b to include entries that define the users' membership in the group. For example, FIG. 4B shows that group management service 201 has added four entries to group membership table 202b each of which maps a user ID to the Group123 group ID. These entries also define a status of each user's membership. As shown, John Hansen (User_1) can be automatically registered as a group member since he requested creation of the group. In contrast, the status for the other three users in the group can be set to “Invitation to be sent” or some other value that represents that the user has yet to be invited to the group.

With the tables in group management database 202 updated appropriately, group management service 201 can send requests to join the new group to each member specified in the group creation request (other than to John Hansen since he created the group). This request can include the particular settings for the group (e.g., pay in amount, group type, who the creator of the group is, etc.). In this example, because email addresses are used as the contact information, group management service 201 can send the requests as emails. As shown as step 3 in FIG. 4C, it will be assumed that the three other members of John's Group use user devices 104b, 140c, and 104d such that the emails will ultimately be routed to these devices. In some embodiments, these emails can include a link to download or open the corresponding mobile application, a link to a website where the individual can register with the platform, etc.

In response to receiving the requests to join the group, and depending on whether or not the individual is a registered user, each individual can cause a response to be sent back to group management service 201. As depicted in FIG. 4D as step 4, in the case where the individual is not a registered user, the mobile application, website, or other interface employed on the user device can prompt the individual to provide any information that is necessary to complete the registration process. For example both user device 104b and user device 104d, which are assumed to be used by Jill Taylor and Bob Turner respectively, respond with a registration request that includes the individual's name. This registration request can also serve as confirmation that the to-be-registered user will join the group. In contrast, user device 104c, which is assumed to be used by Adam Smith who is already registered, is shown as responding with a simple confirmation. In step 5, group management service 201 can process the responses by updating users table 202c as necessary. In this case, group management service 201 updates the User_3 and User_6 entries to include the first and last names provided in the registration requests.

Next, as shown in FIG. 4E, the registration process continues with group management service 201 redirecting the registration process to transaction service 301 in step 6. To be registered as a user on the group investment management platform, it is necessary that the user provide financial account information. Group management service 201 can redirect the registration process to transaction service 301 so that the process of obtaining this financial account information is performed by transaction server 102 rather than by management server 101. As a result, the sensitive financial information can be handled in a more secure manner and separately from the other user information. Although not shown, the redirection of the registration process can entail providing sufficient information to transaction service 301 to allow transaction service 301 to retrieve financial account information only from users that have not previously provided such information or from users whose previously provided information is no longer valid. In the present example, transaction service 301 can be configured to request account information only from user devices 104b and 104d as represented in step 7. In mobile application embodiments, this can be accomplished by presenting an interface within the mobile application that is configured to request the appropriate financial account information from the user and then transfer the received information to transaction service 301. In a web-based embodiment, this could be accomplished by redirecting the browser to a website that is configured to post input to transaction service 301.

In step 8 shown in FIG. 4F, both Jill Taylor and Bob Turner (via their respective user devices) can provide their account information to transaction service 301. In response, and in step 9, transaction service 301 can update accounts table 302a appropriately. For example, FIG. 4F shows that an entry for User_3 (Jill Taylor) which defines an “ACH” account type with an account number of “743 . . . ” and an entry for User_6 (Bob Turner) which defines a “Debit” account type with an account number of “234 . . . ” have been created. As is also shown, entries for User_1 (John Hansen) and User_5 (Adam Smith) had already been created.

In step 10 shown in FIG. 4G, once account information is received from a user and accounts table 302a has been updated accordingly, transaction service 301 can inform group management service 201 that account information for the user has been successfully obtained. In response, in step 11, group management service 201 can update group membership table 202b to reflect that the particular user now has a status of registered. This step could also be performed in response to step 4 if the user is already registered. In other words, once the user has registered and/or confirmed that he or she would like to join the group and if/once the user has provided account information, the user's status in the group can be set to registered. Once all invited members are registered in the group (e.g., once every entry for the group in group membership table 202b has a status of “Registered”), group management service 201 can update groups table 202a so that the status of the corresponding entry is set to “Active” as shown in step 12.

Finally, in step 13 shown in FIG. 4H, group management service 201 can send a notification of group activation to each member in the group. Group management service 201 can accomplish this by locating each entry in group membership table 202b having a group ID of Group123, extracting the user ID from each located entry, and then using the extracted user IDs to retrieve the email address (or other identifier such as an identifier used by the mobile application to uniquely identify a user) from users table 202c. In this way, each member will be notified that the group has been successfully created and will be managed in accordance with the defined settings.

The specific process depicted in FIGS. 4A through 4H as well as the unique data structures and components employed in this process allow groups to be created in an efficient and secure manner. Notably, the separation of functions between group management service 201 and transaction service 301 and the separation of the data into a number of unique tables (or other data structures) enhances and improves the capabilities of the hardware system(s) that may be used to host these components.

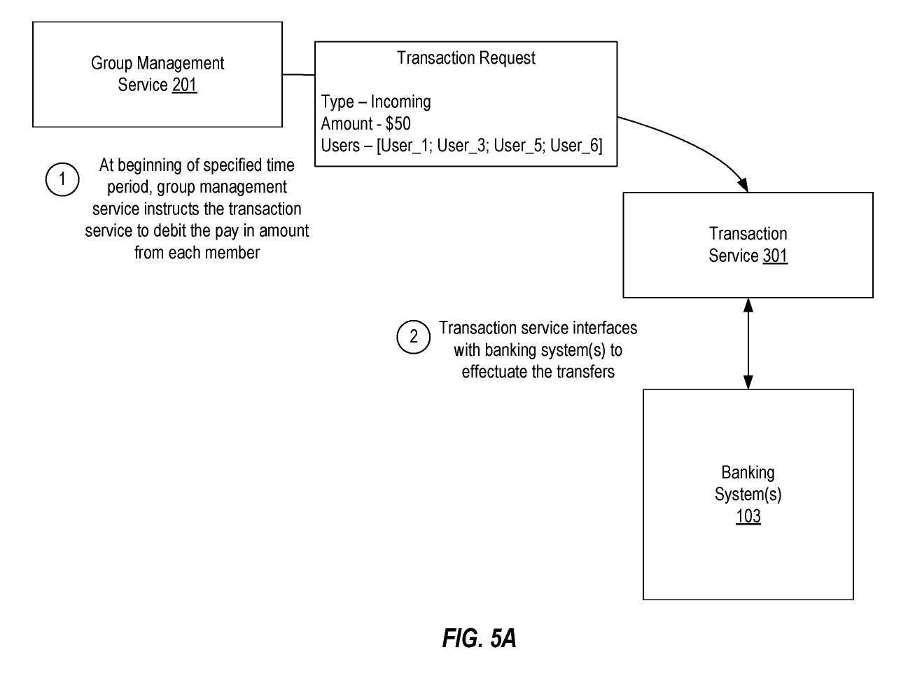

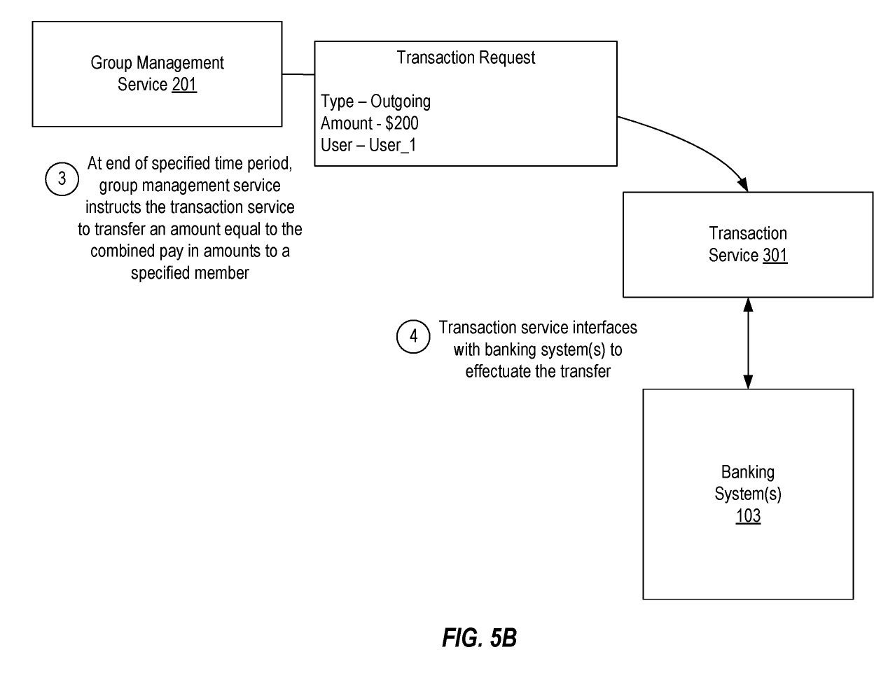

With a group is established, group management service 201 and transaction service 301 can continue to interoperate in an efficient and secure manner to implement a group investment scheme as represented in FIGS. 5A and 5B. Continuing the same example as above, once John's Group is set active, group management service 201 can commence the investment process. For example, group management service 201 can access groups table 202a to identify the pay in amount for Group123 which in this case is $50. Then, as shown in FIG. 5A as step 1, group management service 201 can send a transaction request to transaction service 301. This transaction request can identify the type of the transaction (which would be an incoming payment in this case), the amount of the transaction (which would be $50), and the users (which would be the users having user IDs of User_1, User_3, User_5, and User_6) to whom the transactions should be made. In some embodiments, group management service 201 can be configured to send a transaction request at the first of each month while the group remains active. Alternatively, as part of the group creation process, the user may specify a date or dates on which transaction requests should be sent (e.g., on the 15^{th} of each month).

Upon receiving the transaction request, transaction service 301 can employ the user IDs specified in the transaction request to retrieve the appropriate account information from accounts table 302a and use this information to interface with banking system(s) 103 to effectuate the transactions. As an example, the group investment management platform may maintain an account with banking system(s) 103 into which the pay in amounts can be temporarily deposited. In typical embodiments as will be further described below, steps 1 and 2 can be repeated on a periodic (e.g., monthly) basis to implement a group investment scheme.

In step 3 as shown in FIG. 5B, after a specified time period (such as a month) or at least after each member's pay in has been received, group management service 201 can send a transaction request which instructs transaction service 301 to initiate an outgoing transaction to transfer an amount equal to the sum of the group's pay in amounts to one of the user's accounts. In this example, it is assumed that User_1 (John Hansen) has been selected to receive the payout of $200. Accordingly, in step 4, transaction service 301 can employ the account information defined for User_1 in accounts table 302a to cause $200 to be transferred to John's account. Although not shown, once the payout is successfully transferred to John's account, transaction service 301 may notify group management service 201 which can in turn update group membership table 202b to reflect that John has received a payout as part of Group123.

Because John's Group is configured as a turn-based group, each member of the group will receive a payout in some specified order. For example, John may receive the $200 payout at the end of the first month, Jill may receive the $200 payout at the end of the second month, Adam may receive the $200 payout at the end of the third month, and Bob may receive the $200 payout at the end of the fourth month. Alternatively, in John's Group was configured for random payout, group management service 201 could select a member randomly from those that have yet to receive a payout. After each member has received a payout, the group will have become completed, and group management service 201 can update groups table 202a accordingly (e.g., by changing the status to completed). At this point, John and/or other members of the group can be presented with the option to restart the group which could result in the process being repeated (e.g., by setting Group123's status to pending to cause steps 3, 4, 11 and 12 to be repeated). If any member declined the request to again join the group (or equally to join the group at the initial iteration), that member could be removed from the group (e.g., by removing/deactivating the corresponding entry from group membership table 202b and updating the entry in groups table 202a accordingly).

As can be seen, the group investment management platform facilitates the implementation of group investment schemes where each member of the group provides a pay in during each period and receives a payout during one period of the group's lifetime. Many users will view such an investment scheme as fun and entertaining and will therefore be more likely to participate. It is noted, however, that the present invention is not directed to a group investment scheme, but is directed to the group investment management platform that enables such a scheme to be implemented, not only in an efficient and secure manner, by in a manner that enhances the functionality of the hardware components on which the platform may be implemented and that improves upon previously available platforms.

The segregation of group management service 201 and its associated data structures from transaction service 301 and its associated data structures creates an architecture that is better suited for distributed environments and therefore facilitates the implementation of the group investment management platform in a mobile-application-based environment. This segregation also facilitates the implementation of security schemes for the protection of sensitive financial information without unduly limiting the performance of other functions within the platform. In short, the present invention improves the functionality of a distributed system.

Embodiments of the present invention may comprise or utilize special purpose or general-purpose computers including computer hardware, such as, for example, one or more processors and system memory. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A group investment management platform comprising:
a management server that implements a group management service and a group management database; and
a transaction server that implements a transaction service and a transaction database;
wherein the group management service is configured to:
interface with user devices to receive requests to create groups within the group investment management platform;
in response to receiving a request to create a group, update one or more data structures in the group management database to define the group and membership in the group; and
interface with the transaction server to instruct the transaction service to obtain and manage account information for members of the group; and
wherein the transaction service is configured to:
in response to requests from the group management service, interface with the user devices to retrieve the account information in a secure manner;
in response to receiving the account information, update one or more data structures in the transactions database; and
interface with the group management service to notify the group management service when account information has been obtained from the members of the group.

2. The group investment management platform of claim 1, wherein the one or more data structures in the group management database include a groups data structure, a group membership data structure, and a users data structure.

3. The group investment management platform of claim 2, wherein the groups data structure includes entries each of which defines a particular group.

4. The group investment management platform of claim 3, wherein each entry in the groups data structure defines a type of the group and a pay in amount for the group.

5. The group investment management platform of claim 2, wherein the group membership data structure includes entries each of which identifies a particular group and a particular user that is a member of the particular group.

6. The group investment management platform of claim 2, wherein the users data structure includes entries each of which defines a unique identifier of a user.

7. The group investment management platform of claim 1, wherein the one or more data structures in the transactions database include an accounts data structure and a transactions data structure.

8. The group investment management platform of claim 7, wherein the accounts data structure includes entries each of which identifies a particular user and account information for the particular user.

9. The group investment management platform of claim 7, wherein the transactions data structure includes entries each of which defines a transaction that has been made against a user's account that is defined in the accounts data structure.

10. The group investment management platform of claim 1, further comprising:
a mobile application that executes on the user devices and that is configured to send the requests to create groups to the group management service and to send the account information to the transaction service.

11. The group investment management platform of claim 1, wherein the group management service is configured to send a first transaction request to the transaction service which identifies a pay in amount and each member of a group from whose account the pay in amount should be deducted.

12. The group investment management platform of claim 11, wherein the group management service is further configured to send a subsequent transaction request to the transaction service which identifies a payout amount and a particular member of the group to whose account the payout amount should be transferred.

13. The group investment management platform of claim 12, wherein the group management service selects the particular member randomly from among the members of the group that have not previously received the payout amount.

14. The group investment management platform of claim 1, wherein the group management service is further configured to:
in response to receiving the request to create the group, access the one or more data structures in the group management database to determine which individuals specified in the request are not registered as users of the group management platform; and
for each individual that is determined to not be a registered user:
send a registration request to a user device of the individual, the registration request including an invitation to join the group; and
instruct the transaction service to request account information from the individual.

15. A method for implementing a group investment management platform comprising:
configuring a management server to include a group management service;
configuring a transaction server to include a transaction service;
receiving, at the group management service, a request to create a group, the request specifying a plurality of individuals as members of the group and a pay in amount for the group;
creating, by the group management service, an entry in a groups data structure that defines the group, the entry including an identifier of the group and the pay in amount;
creating, by the group management service, an entry in a group membership data structure for each of the individuals, each entry associating the individual with the group;
sending, by the group management service, invitations to each of the individuals to join the group;
in response to an individual accepting the invitation, causing the transaction service to request account information from the individual;
in response to receiving account information from each of the individuals, instructing the transaction service to deduct the pay in amount from an account of each individual using the corresponding account information; and
after the pay in amount has been deducted from the account of each individual, instructing the transaction service to transfer an amount equal to the sum of the deducted pay in amounts to the account of one of the individuals.

16. The method of claim 15, wherein sending invitations to each of the individuals to join the group comprises sending an email to each individual using an email address specified in the request to create the group.

17. The method of claim 16, wherein causing the transaction service to request account information from the individual comprises causing a mobile application on a user device employed by each individual to request the account information from the individual, the mobile application being configured to route the account information to the transaction service.

18. The method of claim 15, wherein the transaction service stores the account information in an accounts data structure that is isolated from the group management service.

19. The method of claim 15, wherein the group management service randomly selects the individual to receive the sum of the deducted pay in amounts from among individuals in the group that have not previously received the sum of the deducted pay in amounts.

20. One or more computer storage media storing computer executable instructions which when executed by one or more processors implement a method for implementing a group investment management platform, the method comprising:
configuring a management server to include a group management service and a group management database;
configuring a transaction server to include a transaction service and a transaction database, the transaction service and the transaction database being isolated from the group management service;
receiving, at the group management service, a request to create a group, the request specifying a plurality of individuals as members of the group and a pay in amount for the group;
creating, by the group management service, an entry in a groups data structure that defines the group, the entry including an identifier of the group and the pay in amount;
creating, by the group management service, an entry in a group membership data structure for each of the individuals, each entry associating the individual with the group;
sending, by the group management service, invitations to each of the individuals to join the group;
in response to an individual accepting the invitation, causing the transaction service to request account information from the individual;
in response to receiving account information from each of the individuals, instructing the transaction service to deduct the pay in amount from an account of each individual using the corresponding account information; and
after the pay in amount has been deducted from the account of each individual, instructing the transaction service to transfer an amount equal to the sum of the deducted pay in amounts to the account of one of the individuals.
